(19) United States
(12) Patent Application Publication
(10) Pub. No.: US 2026/0251263 A1
(43) Pub. Date: Aug. 27, 2026

(54) PRESSURIZED FLUID CONTAINER

(71) Applicant: EIFHYTEC, STRASBOURG (FR)

(72) Inventor: Corentin Siegwald, STRASBOURG (FR)

(21) Appl. No.: 18/707,242

(22) PCT Filed: Nov. 3, 2022
(86) PCT No.: PCT/EP2022/080735

§ 371 Date: May 4, 2026

(30) Foreign Application Priority Data
Nov. 5, 2021 (FR) FR2111750

(51) Int. Cl. F17C 1/00

(52) U.S. Cl. CPC F17C 1/00; F17C 2201/0109; F17C 2201/0114; F17C 2205/0311; F17C 2209/228; F17C 2221/011; F17C 2221/012; F17C 2221/014; F17C 2223/033; F17C 2223/035; F17C 2223/036

(57) ABSTRACT

The present invention relates to a pressurized fluid container having a body and at least one end piece (1), said body comprising a central portion (2) having a cylindrical shape and connected at its longitudinal ends to two body ends, said at least one end piece being attached to a first body end (3) by at least one pin (4), said pin (4) comprising: at least one first part (4a) housed in a body opening (5) passing at least in part through a side wall of said first body end, and at least one second part (4b) housed in an end piece opening (6) passing at least in part through a side wall of said end piece (1). The present invention also relates to a process for manufacturing a container according to the invention.

The present invention relates to the field of pressurized fluid storage. More particularly, it concerns a pressurized fluid container.

Pressurized gases are usually stored in partly cylindrical containers closed by stoppers. In order to limit the force exerted on the stopper, the containers often have a constriction near the stopper, so that the stopper does not have to cover the entire width of the container. The problem with this constriction is that it increases the cost of manufacturing the container. In addition, the narrowing makes it impossible to insert a heat exchanger into the container through the opening closed by the stopper, or severely limits the dimensions of such an exchanger and therefore its efficiency.

To solve this problem, there are stoppers made with flanges covering the entire width of the container. These flanges are secured by screws. To withstand the forces exerted by the pressurized fluid, it is necessary to use a large number of screws, which increases the cost of the container. What's more, the flange often occupies a much larger diameter than the rest of the container, which increases the container's overall dimensions.

There are also two-part stoppers. A first part is inserted inside one end of the container body and includes a sealing seal. A second part is inserted after the first part, and is threaded onto the container body. When the second part is tightened to the container body, it presses on the first part to seal the container. This solution is costly, as it is made up of complex components, and it reduces the thickness of the container in the vicinity of the stopper, and therefore its resistance to pressure.

One of the aims of the present invention is to provide a container with an end piece that limits the size of the container, while maintaining satisfactory resistance to pressure.

A further object of the present invention is to provide a container with an end piece that is simple and inexpensive to manufacture, and easy to use.

Another object of the present invention is to provide a container that can easily take different shapes, and hold different fluids, and be adapted to different pressures.

The object of the present invention is to respond at least in part to the aforementioned objects by proposing a container comprising an end piece held in place by transverse pins. To this end, it proposes a pressurized fluid container comprising a body and at least one end piece secured to said body by at least one pin, said pin comprising:
at least one first part housed in a body opening passing at least in part through a side wall of said body, and
at least one second part housed in an end piece opening passing at least in part through a side wall of said end piece.

Thanks to these arrangements, an end piece covering the entire width of the container interior can be maintained over a wide range of pressures, including high pressure levels, without having to modify the thickness of the container wall, and with a minimum container footprint.

Further features include:
said body opening and said end-piece opening can be aligned in a direction perpendicular to the force induced by the fluid pressure tending to separate the end-piece from the body, allowing optimum retention of the end-piece under this force,
said container may comprise at least four pins; this is a simple and robust way of implementing the invention, and allows forces to be distributed around the circumference of the container,
the cross-section of said at least one pin can have a larger dimension in the direction of the force induced by the fluid pressure tending to separate the end piece from the body than in the direction transverse to said force, enabling the container to be used for higher pressure values, without the need to increase the thickness of the container walls in the region of the end piece,
the end piece may comprise a seal, preferably an O-ring seal, housed between a body shoulder and an end piece shoulder, and one of said at least one pin has a smaller cross-section at the end of the end piece opening facing the inside of the container than its cross-section at the end of the body opening facing the outside of the container, and said at least one pin comprises a clamping means, such as a screw, configured to exert a driving force on said pin in the body and end piece openings, thus ensuring a good seal of the container for certain applications, with a simple and robust means of obtaining a compression means of the seal,
said body can comprise a central part having a cylinder shape and connected at its longitudinal ends to two body ends, said pin being able to fix said at least one end piece at a first body end, said body opening being able to pass through the side wall of said body at said first body end, which is a particularly efficient type of container for storing fluid under pressure, the external shape of said first body end can extend the cylinder formed by said central part, and at least part of the end piece can be arranged inside said first body end, which avoids any enlargement of the container at the end piece, and makes the container particularly easy and inexpensive to manufacture, said container can further comprise a heat exchanger, a main part of which is located in the central part, the maximum dimension of said main part measured on a section of the cylinder formed by the central part of the container being able to be, for example, between 50 and 100% of the surface area of said section, which makes it possible to efficiently heat or cool a fluid contained in the container,
the cylinder formed by said central part can be a circular cylinder, which is a simple and robust implementation of the invention and optimizes stress distribution.

The present invention also relates to a process for manufacturing a container according to the invention and comprising the following steps:
manufacture of a body comprising a cylindrical central part and two body ends,
drilling at least one body opening in the wall of said first body end and at least one end piece opening in the wall of said end piece,
arrangement of the end piece in or around said first body end,
arranging said at least one pin so that it passes at least partially through said at least one body opening and said at least one end piece opening.

The result is a container in which an end piece covering the entire width of the container interior can be held in place at high pressure levels, without having to modify the container wall thickness, and with a minimum container footprint.

The present invention will be better understood on reading the detailed description that follows, with reference to the appended figures in which:

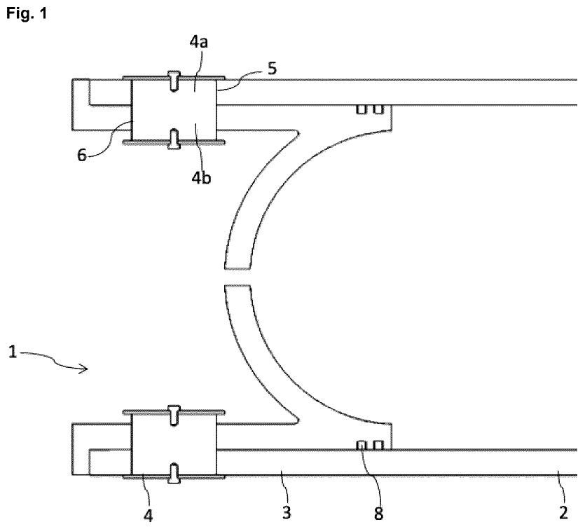

FIG. 1 is a cross-sectional view of one end of a container according to a first embodiment of the invention.

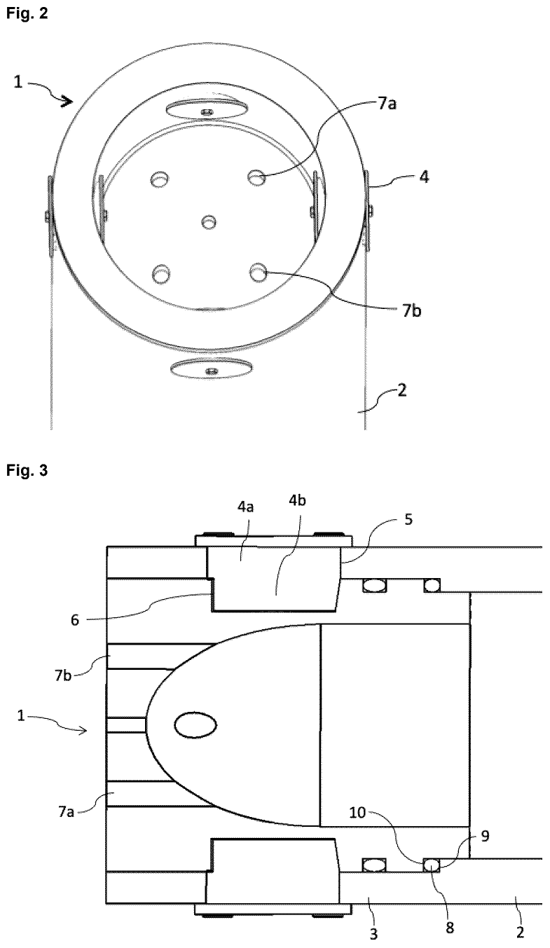

FIG. 2 is a perspective view of the container shown in FIG. 1.

FIG. 3 is a cross-sectional view of one end of a container according to a second embodiment of the invention.

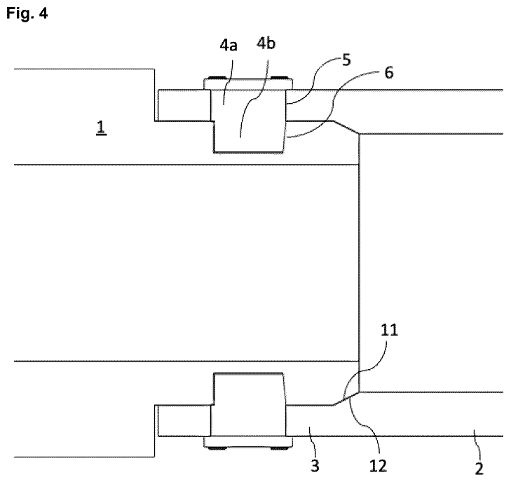

FIG. 4 is a cross-sectional view of one end of a container according to a third embodiment of the invention.

The container according to the invention, an embodiment of which is illustrated in FIGS. 1 and 2, is suitable for containing a pressurized fluid. The fluid is preferably a gas, such as dihydrogen, oxygen or nitrogen. The pressure of the fluid is, for example, between 1.015 and 1500 bar.

The container comprises a body and at least one end piece 1.

The container can be a fluid storage tank, the end piece being, for example, a stopper 1, as illustrated in FIG. 1à 3.

The container can also be part of a machine, for example a chamber forming part of a fluid compressor, the end piece being, for example, a stopper 1.

The container can also be a pipe, containing a fluid under pressure and in which a tube of the pipe is attached to a connector. The body can then be a pipe and the end piece a connector, as shown in FIG. 4, or conversely, the body can be a connector and the end piece a pipe. In some embodiments, it is preferable for the end piece to be the connector and the body to be the pipe. This is because the modifications to be made to a standard connector or tube to produce an end piece according to the invention are more complex than the modifications to be made to produce a body according to the invention. As the fitting is usually a more complex part to manufacture than the pipe, it is advantageous to keep the most complex manufacturing operations on the fitting.

The body may comprise a central part 2, shaped like a cylinder, a first body end 3, connected to the central part 2 at a first longitudinal end of the cylinder formed by the central part 2, and a second body end, connected to the central part 2 at the second longitudinal end of the cylinder formed by the central part 2. The majority of the fluid is then contained within the cylinder. These arrangements are particularly suitable when the container is a fluid reservoir.

The cylinder is preferably circular, which has the advantage of being easy to manufacture and better able to withstand the pressure of the fluid stored in it. However, other cylinders are also possible, for example with a square, oblong or rectangular cross-section.

Alternatively, the body may not have a cylindrical central part. This is particularly the case when the container is a chamber, for example of a fluid compressor, and when the chamber is formed at least in part by, for example, a concave surface present on the end piece and/or body.

The end piece 1 is attached to the first body end 3 by means of at least one pin 4. The at least one pin 4 is located at the side walls of the body and end piece 1. By “side walls” we mean walls extending substantially in the same direction as the force induced by the fluid pressure tending to separate the end piece 1 from the body. This may be the same direction, or a slightly different one, for example of the order of 1 to 5°.

If the body has a cylindrical central part 2 and a first body end 3, the at least one pin 4 is located at the side wall of the first body end 3. If the first body end 3 extends the cylinder, the side wall may be an extension of the cylinder walls. In other cases, it may be an extension slightly offset towards the inside or outside of the cylinder.

The side wall can be flat or curved.

In some embodiments, the container may comprise a single end piece 1, located at the first body end 3. In other embodiments, the container may comprise two end pieces 1, located on opposite sides of the body.

To allow the pin 4 to pass through, the side wall of the body is at least partially penetrated by a body aperture 5, and the side wall of the end piece 1 is at least partially penetrated by an end piece aperture 6.

Pin 4 comprises a first part 4a, housed in body opening 5, and a second part 4b, housed in end-piece opening 6.

Several configurations are possible.

If the body opening 5 passes completely through the side wall of the body and the end piece opening 6 passes completely through the side wall of the end piece 1, the pin 4 may comprise, in addition to its first and second parts 4a, 4b, two other parts opening out on either side of the openings 5, 6, fitted with holding means such as a head and a nut, or with one nut each.

If the body opening 5 only partially passes through the body side wall, the pin 4 may have only a through portion on the side of the end piece opening 6. In this case, the pin can be inserted into the openings 5, 6, first passing through the end-piece opening 6.

If the end-piece opening 6 only partially penetrates the side wall of the end piece 1, the pin 4 may have only one open end, on the side of the body opening 5. In this case, the pin can be inserted into openings 5, 6, first through body opening 5.

Preferably, for each pin 4, the body 5 and end piece 6 openings are aligned in a direction perpendicular to the force induced by the fluid pressure tending to separate the end piece 1 from the body. The direction of this force may, for example, coincide with the longitudinal axis of the cylinder formed, where applicable, by the central part 2 of the container body. If the cylinder is circular, the openings 5, 6 are preferably aligned along a straight line passing through the longitudinal axis of the cylinder. In this way, pin 4 is optimally positioned to prevent movement of end piece 1 relative to the container body, in the direction of the force induced by the fluid pressure tending to separate end piece 1 from the body. The of body 5 and end piece 6 openings are then preferably adjacent, the side walls of end piece 1 and body being in contact with each other in the vicinity of their openings 5, 6. The pins 4 and openings 5, 6 can preferably be distributed over the entire circumference of end piece 1 around the longitudinal axis of the cylinder. In this way, any movement of the end piece 1 relative to the body is impossible once the pins 4 are in place.

In a particular embodiment illustrated in FIGS. 1 and 2, the outer shape of the first body end 3 can extend the cylindrical outer shape of the central part 2. The end piece 1 can then be at least partially arranged in the first body end 3. In this way, the size of the container is limited, and the container according to the invention is particularly simple to manufacture.

In a preferred embodiment of the invention, illustrated in FIG. 2, the container comprises a plurality of pins 4, for example four pins, evenly distributed around the perimeter of the end piece 1. The number of pins 4 will be easily determined by the person skilled in the art, in particular as a function of the dimensions of the container, the pressure of the fluid stored therein, and the shape and dimensions of the pins 4. It is possible to arrange one or more rows of pins 4 around the perimeter of the side walls of the end piece and the body.

Pin 4 can be cylindrical in shape. The cross-section of pin 4 can then be circular, as illustrated in FIGS. 1 and 2. Alternatively, the cross-section may be square, providing greater shear strength for similar cross-sectional dimensions.

In a particular embodiment, the cross-section of the pin 4 is larger in the direction of the force induced by the fluid pressure tending to separate the end piece 1 from the body, than in the direction transverse to this force. For example, this may be a pin with an oblong cross-section, or even a rectangular cross-section, which offers the same advantages over the oblong cross-section as those previously mentioned for the square cross-section over the circular cross-section. This increases the pin's resistance to the pressure inside the container, enabling it to store a fluid at very high pressure, e.g. 1200 bar.

The container may include a heat exchanger, suitable for cooling or heating the fluid it contains. The heat exchanger preferably comprises elements in which a heat transfer fluid circulates, distributed as far as possible inside the body of the container, for example all along the longitudinal axis and over the entire cross-section of the cylinder formed by the central part 2, in order to achieve the most efficient heat exchange possible between the heat transfer fluid and the fluid stored in the container. The maximum overall dimension of the part of the heat exchanger located in the central part, measured over a section of the cylinder formed by the central part 2 of the container, is, for example, between 50 and 100% of the surface area of said section. The overall dimensions are defined as the smallest convex surface area completely covering a section of the heat exchanger. The container has at least two holes 7 in which heat transfer fluid transfer means can be arranged, one hole 7a for entry into the container and one hole 7b for exit. The two holes 7 may, for example, be located on the same end piece 1, or in the event that the container comprises two end pieces 1, one hole 7 may, for example, be located on each end piece 1.

The end piece 1 preferably has an end wall, closing off the body. The holes 7 can then be located on this end wall.

To seal the container, end piece 1 preferably comprises at least one seal 8, for example an O-ring 8, arranged between end piece 1 and first body end 3 at a longitudinal support means. Seal 8 may also, for example, be a four-lobe seal with four lobes in cross-section, or a flat seal.

In a particular embodiment illustrated in FIG. 3, the longitudinal support means comprises a body shoulder 9 and an end piece shoulder 10, and O-ring 8 is housed between body shoulder 9 and end piece shoulder 10. Other shapes than shoulders can be implemented to obtain the longitudinal support means. For example, the longitudinal support means may comprise a body tapered surface 11 and an end piece tapered surface 12.

The container may include means for compressing seal 8, which is necessary in some applications to ensure a good seal. In other embodiments, seal 8 is not compressed. In still other embodiments, the container comprises a plurality of seals 8. The seals 8 may then all be compressed, or one or more of them may be compressed, or none of them compressed.

In the body design comprising a cylindrical central part 2 and a first body end 3, the means of compressing the O-ring 8 can, for example, be achieved by the particular shape of one or more pins 4. For example, a pin 4 may have a smaller cross-section at the end of the end-piece aperture 6 on the inside of the container than its cross-section at the end of the body aperture 5 on the outside of the container. The pin 4 may then comprise a clamping means, such as a screw, configured to exert a force to press the pin 4 into the body 5 and end piece 6 openings. The end-piece opening 6, respectively the body opening 5, may in this case not pass through the side wall of the end piece 1, so that the screw can engage in the part of the side wall of the end piece 1, respectively of the body, remaining at the bottom of the end-piece opening 6, respectively of the body opening 5. In this way, the compression level of the O-ring 8 can be adjusted to the level at which the clamping means is tightened. The clamping means also prevents the pin 4 from being pushed out of or into the container.

In another embodiment, sealing is achieved without a seal 8. As in the previous embodiment, a pin 4 may have a smaller cross-section at the end of the end-piece aperture 6 facing the inside of the container, than its cross-section at the end of the body aperture 5 facing the outside of the container. The pin 4 may then comprise a clamping means, such as a screw, configured to exert a force to press the pin 4 into the body 5 and end piece 6 openings. The shape of the longitudinal support means ensures a sufficient seal when the clamping means is applied. The longitudinal support means may comprise a body shoulder 9 and an end piece shoulder 10, or a body tapered surface 11 and an end piece tapered surface 12, as shown in FIG. 4, or any other shape suitable for the invention.

When at least one pin 4 is cylindrical, a means of preventing its movement along its axis can be provided, to ensure that it does not fall into or out of the container. Several solutions are then possible, all the more so as there is no particular force in this direction against which the pin must resist, apart from, depending on the position of the container, the pin's own weight 4. In the case of pins 4 with a circular cross-section, a thread can be provided at their ends, onto which nuts can be screwed. In all cases, crossbars or plates can be fitted to the ends of the pin 4 to prevent any longitudinal movement of the pin 4, if necessary by abutting the side walls of the body and/or end piece 1. An example is shown in FIGS. 1 and 2, with discs attached to the pin ends by screws inserted in threaded holes in the pin 4 ends. Other solutions are still possible, and within the reach of the person skilled in the art.

In certain container configurations, and where the container comprises a plurality of pins 4, the pins 4 can be designed as resilient pins, i.e. their cross-section can be reduced when a force is exerted on them. These may be hollow, slotted pins of the “mechanindus” type (registered trademark). If, due to manufacturing tolerances, one or more pins 4 have a smaller cross-section than the others, or are located in larger openings 5, 6, or the body 5 and end-piece 6 openings are not precisely opposite each other, it is possible that one pin 4 is the only one to be subjected to the force exerted by the pressurized fluid stored in the container. In this case, this pin 4 is subjected to a greater stress than anticipated and may break, transferring the stress to the next pin 4, which may then also break, and so on. The use of resilient pins prevents the other pins 4 from breaking by allowing their cross-section to contract, until the pins 4 of the first group contribute to the holding force of the end piece 1. In this way, manufacturing tolerances prevent the force exerted by the pressurized gas from not being exerted on all the pins, but only on one or more of them.

In other container configurations, the intrinsic elasticity of pins 4 may be sufficient to compensate for tolerance deviations, which can be reduced to sufficiently small values.

The container may comprise a means of positioning the end piece. This may, for example, be a groove located on the container body, and cooperating with a rib located on the end piece 1. When the end piece 1 is installed on the container, this ensures alignment between the body 5 and pin 6 openings.

Example:
the body comprises a cylinder formed by a central part 2, said cylinder being a circular cylinder with a diameter of between 180 and 220 mm, and a length of one meter,
the end piece 1 has four circular cylindrical pins with diameters ranging from 40 to 60 mm,
the fluid in the container is at a pressure of between 400 and 500 bar.

The container according to the invention can be manufactured according to a process comprising the following steps:
manufacture of a body comprising a cylindrical central part 2 and two body ends 3, and an end piece 1,
drilling at least one body opening 5 in the wall of said first body end 3 and at least one end piece opening 6 in the wall of said end piece 1,
arrangement of end piece 1 in or around said first body end 3, arranging said at least one pin 4 so that it passes through said at least one body opening 5 and said at least one end piece opening 6.

Although the above description is based on particular embodiments, it is by no means limitative of the scope of the invention, and modifications may be made, in particular by substitution of technical equivalents or by different combination of all or some of the features developed above.

1-12. (canceled)

13. A pressurized fluid container comprising a body and at least one end piece attached to said body by at least one pin, said pin comprising:
(a) at least one first part housed in a body opening passing at least in part through a side wall of said body; and
(b) at least one second part housed in an end piece opening passing at least in part through a side wall of said end piece,
wherein the cross-section of said at least one pin has a larger dimension in the direction of the force induced by the pressure of the fluid tending to separate the end piece from the body than in the direction transverse to said force.

14. The container according to claim 13, further comprising a longitudinal support means, one of said at least one pin having a smaller cross-section at the end of the end piece opening located on the inside of the container than its cross-section at the end of the body opening located on the outside of the container, than its cross-section at the end of the body opening facing the outside of the container, and said at least one pin comprises a clamping means, such as a screw, configured to exert a force to press said pin into the body and end-piece openings.

15. The container according to claim 14, wherein said longitudinal support means comprises a body shoulder and an end piece shoulder, the end piece preferably comprising a seal, for example an O-ring, housed between said body shoulder and said end piece shoulder.

16. The container according to claim 14, wherein said longitudinal support means comprises a body tapered surface and an end piece tapered surface.

17. The container according to claim 13, wherein said body opening and said end piece opening are aligned in a direction perpendicular to the force induced by the fluid pressure tending to separate the end piece from the body.

18. The container according to claim 13 comprising at least four pins.

19. The container according to claim 13, wherein said end piece is a stopper.

20. The container according to claim 13, said body comprising a central part having a cylinder shape and connected at its longitudinal ends to two body ends, said pin securing said at least one end piece at a first body end, said body opening passing through the side wall of said body at said first body end.

21. The container according to claim 20, wherein the external shape of said first body end extends the cylinder formed by said central part, and at least part of the end piece (1) is disposed inside said first body end.

22. The container according to claim 20 further comprising a heat exchanger, a main part of which is located in the central part, the maximum overall dimensions of said main part measured on a section of the cylinder formed by the central part of the container being for example between 50 and 100% of the surface area of said section.

23. The container according to claim 20, wherein the cylinder formed by said central part is a circular cylinder.

24. A process for manufacturing the container according to claim 20 comprising the following steps:
a. manufacture of the body comprising a cylindrical central part and two body ends;
b. drilling at least one body opening in the wall of said first body end and at least one end piece opening in the wall of said end piece;
c. arrangement of the end piece in or around said first body end; and
d. arranging said at least one pin so that it passes at least partially through said at least one body opening and said at least one end piece opening.
